(19) United States
(12) Patent Application Publication
(10) Pub. No.: US 2012/0159550 A1
(43) Pub. Date: Jun. 21, 2012

(54) SYSTEM AND METHOD FOR PROVIDING DYNAMIC CONTENT WITH AN ELECTRONIC PROGRAM GUIDE

(75) Inventor: Parimal Bajpai, Bangalore (IN)

(73) Assignee: SLING MEDIA PVT LTD, Bangalore (IN)

(21) Appl. No.: 12/968,569

(22) Filed: Dec. 15, 2010

(51) Int. Cl. H04N 5/445

(52) U.S. Cl. 725/44

(57) ABSTRACT

An electronic program guide (EPG) presented by a set top box (STB) or other television receiver dynamically changes the electronic guide information provided for one or more programs during presentation. In various embodiments, multiple presentation screens for displaying different types of information related to the program are received with the EPG data and sequentially rendered to the viewer. The multiple presentation screens may be manually or automatically sequenced within the guide to provide additional space for presenting information about one or more programs from within the electronic program guide itself.

### TECHNICAL FIELD

The following discussion generally relates to electronic program guides for television receiver devices, and more particularly relates to systems and methods for providing dynamic content within an electronic program guide.

### BACKGROUND

Most television viewers now receive their television signals through a content aggregator such as a cable or satellite television provider. For subscribers to a direct broadcast satellite (DBS) service, for example, television programming is received via a broadcast that is sent via a satellite to an antenna that is generally located on the exterior of a home or other structure. Other customers receive television programming through conventional television broadcasts, or through cable, wireless or other media. Programming is typically received at a receiver such as a “set top box” (STB) or other receiver that demodulates the received signals and that converts the demodulated content into a format that can be presented to the viewer on a television or other display.

Most modern STBs and other television receivers provide an electronic program guide (EPG) feature that allows the viewer to find and select current or future television broadcasts. The EPG feature may also allow viewers to set recording timers to record programs using a digital video recorder (DVR) or the like, to select and control placeshifting features, or to learn more about the various programs that can be received and viewed.

Typically, the receiver obtains data for the EPG from the satellite, cable or other broadcast feed. Most broadcasters currently provide about two weeks worth of EPG data that can be stored in the receiver, and a relatively limited amount of information about each program. Often, however, the types and amounts of data that can be provided for each program are relatively limited by the static nature of most conventional EPG systems. While conventional EPGs are very useful for many purposes, there remains a continual desire to improve and expand upon the features provided by the EPG.

### BRIEF SUMMARY

Various embodiments dynamically change the electronic guide information provided for one or more programs during presentation. According to various embodiments, an electronic program guide (EPG) presented by a set top box (STB) or other television receiver dynamically sequences through multiple presentation screens received with the EPG data during operation. In various embodiments, the various screens of information are manually or automatically sequenced within the guide to provide additional space for presenting information about one or more programs from within the electronic program guide itself.

Some exemplary embodiments provide a method executable by a receiver to provide an electronic program guide on a display. Electronic program guide data is suitably received for a plurality of programs at the receiver. The electronic program guide data for at least one program comprises a first presentation screen that describes first information related to the at least one program and a second presentation screen that describes second information different from the first information that is related to the same at least one program. The electronic program guide data for the plurality of programs is stored, and subsequently retrieved in response to a user input that selects one of the plurality of programs. The first presentation screen is initially rendered to thereby output the first information about the selected program to the display. The second presentation screen is subsequently rendered to thereby output the second information about the selected program to the display.

Other embodiments provide methods executable by a television receiver to provide a dynamic electronic program guide data on a display. The method suitably comprises receiving electronic program guide data for a plurality of programs at the television receiver, wherein the electronic program guide data for at least one program comprises a first presentation screen that describes first information related to the at least one program and a second presentation screen that describes second information related to the same at least one program that is different from the first information; storing the electronic program guide data for the plurality of programs at the television receiver; in response to a user input that selects one of the plurality of programs, retrieving the electronic program guide data for the selected program and rendering the first presentation screen to thereby output the first information about the selected program to the display; and after rendering the first presentation screen, subsequently rendering the second presentation screen to thereby dynamically change the output to the display from the first information to the second information about the selected program.

Still other embodiments provide a receiver to provide television programs for presentation on a display. The receiver comprises a program interface, a storage device, a display interface, and control logic. The program interface is configured to receive broadcast signals from a content aggregator, wherein the broadcast signals comprise signals representing television programs and electronic program guide data, and wherein the electronic program guide data comprises, for each of at least some of the programs, a first presentation screen providing first information about the program and a second presentation screen providing second information about the program that is different from the first program. The control logic is configured to direct the storage of the electronic program guide data in the storage device and, in response to a user input, to retrieve the electronic program guide data corresponding to one of the programs, to render the first information for presentation on the display via the display interface, and to subsequently render the second information for presentation on the display via the display interface.

Various embodiments, aspects and other features are described in more detail below. These and other desirable characteristics will become apparent from the subsequent detailed description and the appended claims, taken in conjunction with the accompanying drawings and the preceding background section.

### BRIEF DESCRIPTION OF THE DRAWING FIGURES

Exemplary embodiments will hereinafter be described in conjunction with the following drawing figures, wherein like numerals denote like elements, and

FIG. 1 is a block diagram of an exemplary broadcast system capable of providing dynamic EPG content to a viewer; and

FIG. 2 is a flowchart of an exemplary process for obtaining and processing dynamic EPG data at a television receiver.

### DETAILED DESCRIPTION

The following detailed description of the invention is merely exemplary in nature and is not intended to limit the invention or the application and uses of the invention. Furthermore, there is no intention to be bound by any theory presented in the preceding background or the following detailed description.

Electronic program guide (EPG) information provided with a cable, direct broadcast satellite (DBS), terrestrial broadcast or other aggregated content television system is made more useful by linking the program description within the EPG to dynamically-changing content related to the program. By providing dynamic content within the EPG itself, the convenience to the user is improved while maintaining the user's focus on the EPG programming. That is, the viewer may not need to use a computer, mobile phone or other separate device to obtain additional information.

More particularly, various embodiments provide systems, devices and methods for dynamically providing electronic program guide (EPG) information to a viewer using a set top box (STB) or other television receiver. Dynamic content that provides additional information about the program is received with the EPG, and displayed as appropriate. In some embodiments, multiple EPG presentation screens are provided for one or more program listings in the EPG, with each screen providing additional information about the program referenced in the listing. Dynamic EPG data for a television program, for example, could include an initial presentation screen that provides conventional program description, channel, broadcast time and other information, along with one or more subsequent presentation screens that provide additional information related to program.

To that end, various embodiments suitably enhance the EPG data to include one or more additional screens of information. The particular information provided may vary significantly from program to program. A telecast of a sporting match, for example, could include additional information that provides team information (e.g., schedules, win/loss record, player rosters, etc.), league or conference information (e.g., standings, schedules, etc.), player information (e.g., statistics, trivia, background or news information, etc.) or any other information as desired. This additional information may be formatted in separate screens that are sequentially presented after the initial screen. Additional information may be provided in response to user inputs in some implementations. Alternately, the various screens associated with each program may be automatically sequenced after an appropriate period of time has elapsed, or the various screens may be automatically and/or manually advanced in any other manner.

The general concepts presented herein may be enhanced in any number of ways. To provide just a few examples, some embodiments may incorporate audio, video, graphical and/or other media content within the additional information provided with the EPG data, as desired. Various embodiments may further embed uniform resource locators (URLs) or other addresses within the received EPG data to thereby allow current information to be obtained from a network server or other appropriate source, thereby conveniently allowing the viewer to access current information directly from the EPG. Other embodiments may have alternate or additional features, as described more fully below.

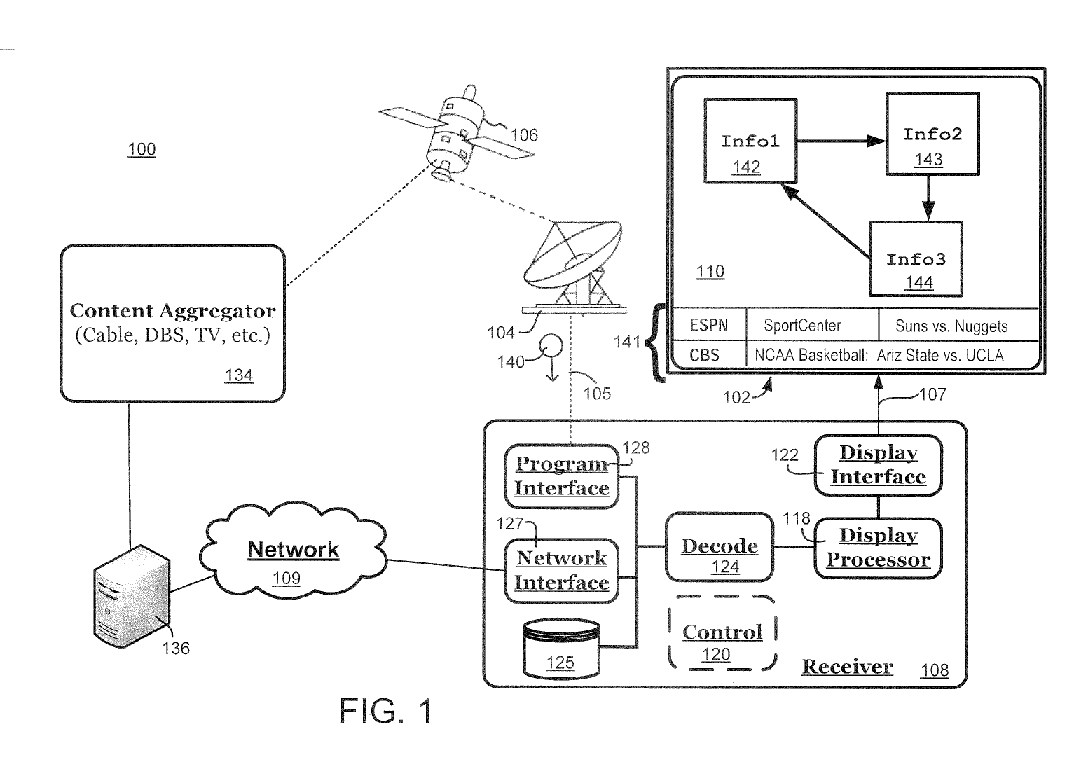

Turning now to the drawing figures and with initial reference to FIG. 1, an exemplary system 100 for presenting television signals to a viewer suitably includes a receiver 108 that receives broadcast signals 105 in any format and that generates appropriate output signals 107 to generate imagery 110 on a display 102. Receiver 108 provides television programming and other features, including the electronic program guide, by generating and rendering imagery no for presentation on display 102.

The electronic program guide feature provided by the receiver 108 is able to process dynamic content that changes over time. For example, dynamic program information may be presented to the viewer in any number of separate presentation screens 142-144 that each provides different information related to the same television program. In the exemplary view shown in FIG. 1, receiver 108 receives EPG data 140 that includes multiple programming screens 142-144 that can be presented in series and/or parallel within imagery 110. The EPG data 140 that contains the dynamic content can be received and stored until needed to generate appropriate EPG imagery on display 102. In various embodiments, the EPG data 140 may include audio, video or other media content formatted in any manner. EPG data 140 may also include uniform resource locators (URLs) or other addressing information that allows information to be obtained from a service 136 that is accessible via the Internet or another network 109.

In FIG. 1, imagery no is shown to provide conventional EPG grid information 141 such as channel, time and program name information, as well as dynamic information about one or more particular programs identified in the EPG. Although FIG. 1 shows three presentation screens 142-144, in practice screens 142-144 may be presented serially in time, with screens 143 or 144 being presented in response to a user input, the elapse of an appropriate timeout period, or any other factors. Other embodiments could provide presentation screens 143-144 as an overlay so that two or more screens 142-144 are simultaneously viewable, as desired, and as described more fully below. Other embodiments may use widely varying screen formats, dimensions, layouts, and the like.

Generally speaking, receiver 108 receives broadcast programming signals 105 from any broadcaster or other content aggregator 134. In the exemplary embodiment illustrated in FIG. 1, receiver 108 is shown receiving digital broadcast satellite (DBS) signals 105 from a satellite 106 via an antenna 104. Equivalent embodiments, however, could receive programming 105 from one or more broadcast or other programming sources 134, including any sort of satellite, cable or broadcast source, as well as any Internet or other network source or the like.

Receiver 108 is therefore any component, device or logic capable of receiving and decoding video signals 105. In various embodiments, receiver 108 is a set-top box (STB) or the like capable of receiving satellite, cable, broadcast and/or other signals 105 that encoding audio/visual content. Receiver 108 may further demodulate or otherwise decode the received signals 105 to extract programming that can be locally viewed on display 102 as desired, as well as EPG data 140 about the various programs as described more fully below. In addition to the EPG feature, various embodiments of receiver 108 may additionally provide place shifting, multi-stream viewing and/or any other features as appropriate. Other types of receivers 108 may be used in any number of alternate but equivalent embodiments.

Display 102 is any device capable of presenting imagery no to a viewer. In various embodiments, display 102 is a conventional television set, such as any sort of television operating in accordance with any digital or analog protocols, standards or other formats. Display 102 may be a conventional television receiver, for example, or any sort of integrated or external display of a computer system, tablet device, mobile phone, or other device as appropriate. In other embodiments, display 102 is a monitor or other device that may not include built-in receiver functionality, but that is nevertheless capable of presenting imagery in response to signals 107 received from receiver 108. In some implementations, receiver 108 and display 102 may be physically combined or interconnected in any manner. A receiver card, for example, could be inserted into a slot or other interface in a conventional television, or the functionality of receiver 108 may be provided within a conventional television display 102. In other embodiments, signals 107 are transferred between receiver 108 and display 102 using any sort of cable or other interface (including a wireless interface). Examples of common interfaces include, without limitation, component video, S-video, High-Definition Multimedia Interface (HDMI), Digital Visual Interface (DVI), IEEE 1394, and/or any other formats as desired.

FIG. 1 provides additional detail about an exemplary receiver 108 that includes a program interface 128, a decoder 124 and a display processor 118, as appropriate. FIG. 1 also shows a storage device 125, an interface 127 to a local or wide area network, a display interface 122, an RF receiver module and control logic 120. Other embodiments may incorporate additional or alternate processing modules from those shown in FIG. 1, may omit one or more modules shown in FIG. 1, and/or may be differently organize the various modules in any other manner different from the exemplary arrangement shown in FIG. 1.

Receiver 108 may be physically and logically implemented in any manner. FIG. 1 shows various logical and functional features that may be present in an exemplary device; each module shown in the figure may be implemented with any sort of hardware, software, firmware and/or the like. Any of the various modules may be implemented with any sort of general or special purpose integrated circuitry, for example, such as any sort of microprocessor, microcontroller, digital signal processor, programmed array and/or the like. Any number of the modules shown in FIG. 1, for example, may be implemented as a “system on a chip” (SoC) using any suitable processing circuitry under control of any appropriate control logic 120. In various embodiments, control logic 120 executes within an integrated SoC or other processor that implements program interface 128, decoder 124, display processor 118 and/or other features, as appropriate. The Broadcom Corporation of Irvine, Calif., for example, produces several models of processors (e.g., the model BCM 7400 family of processors) that are capable of supporting SoC implementations of satellite and/or cable receiver systems, although products from any number of other suppliers could be equivalently used. In still other embodiments, various distinct chips, circuits or components may be inter-connected and inter-relate with each other to implement the receiving and decoding functions represented in FIG. 1. Various embodiments of receiver 108 therefore include any number of appropriate modules for obtaining and processing media content as desired for the particular embodiment. Each of these modules may be implemented in any combination of hardware and/or software using logic executed within any number of semiconductor chips or other processing logic.

Various embodiments of control logic 120 can include any circuitry, components, hardware, software and/or firmware logic capable of controlling the various components of receiver 108. Various routines, methods and processes executed within receiver 108 are typically carried out under control of control logic 120, as described more fully below. Generally speaking, control logic 120 receives user input signals from a remote control or other input device via a radio frequency receiver, infrared receiver, and/or other input/output module 121. Control logic suitably directs the other components of receiver 108 in response to the received inputs to present the desired imagery 110 on display 102.

As noted above, receiver 108 suitably includes a program interface 128, which is any hardware, software, firmware and/or other logic capable of receiving media content via one or more content signals 105. In various embodiments, signals 105 may include cable television, direct broadcast satellite (DBS), broadcast and/or other programming signals as appropriate. In various embodiments, received programming may be provided in real-time (or near real-time) for immediate decoding and presentation to the user. Alternatively, program interface 128 may provide content received from any source to a disk or other storage medium 125 in embodiments that provide DVR functionality. In such embodiments, receiver 108 may also include a disk controller module that interacts with an internal or external hard disk, memory and/or other device that stores non-transitory content as appropriate.

In the embodiment shown in FIG. 1, receiver 108 also includes an appropriate network interface 127, which operates using any implementation of protocols or other features to support communication by receiver 108 on any sort of local area, wide area, telephone and/or other network 109. In various embodiments, network interface 127 supports conventional LAN, WAN or other protocols (e.g., the TCP/IP or UDP/IP suite of protocols widely used on the Internet) to allow receiver 108 to communicate on the Internet or any other network 109 as desired. Network interface 127 typically interfaces with the network using any sort of LAN adapter hardware, such as a conventional network interface card (NIC) or the like provided within receiver 108. Other embodiments may provide interfaces 127 to conventional telephone lines or other communications channels, or may omit network connectivity altogether.

Receiver 108 may include any number of decoder modules 124 for decoding, decompressing and/or otherwise processing received/stored content as desired. Generally speaking, decoder module 124 decompresses, decodes and/or otherwise processes received content to extract an MPEG or other media stream encoded within the stream. The decoded content can then be processed by one or more display processor modules 118 to create a presentation on display 102 for the viewer in any appropriate format. FIG. 1 shows a single decoder module 124 for simplicity. In practice, any number of decoder modules 124 may be used, particularly in “picture in picture” (PIP) situations when multiple signals are simultaneously decoded and displayed. The term “decoder”, then, may collectively apply to one or more decoder modules that are able to decode one or more signals for presentation on display.

Display processor module 118 includes any appropriate hardware, software and/or other logic to create desired screen displays 110 via display interface 122 as desired. Such displays may include combining signals received from one or more decoder modules 124 to facilitate viewing of one or more channels. In various embodiments, display processing module 118 is also able to produce on screen displays (OSDs) for electronic program guide, setup and control, input/output facilitation and/or other features that may vary from embodiment to embodiment. Such displays are not typically contained within received or stored programming, but are nevertheless useful to users in interacting with receiver 108 or the like. The generated displays, including received/stored content and any other displays may then be presented to one or more output interfaces 122 in any desired format. The various dynamic content displays that are described herein, for example, may be generated by display processor module 118 operating alone or in conjunction with control logic 120.

Display processor 118 may also generate imagery 110 in response to viewer inputs received (and/or in response to instructions from command logic 120) to thereby make up a user interface that allows the viewer to scroll or otherwise navigate within the EPG, to select channels or programs or other features of the EPG, to generate the various static or dynamic screen displays described herein, and/or to perform other tasks as desired. As receiver 108 receives user inputs, control logic 120 may direct display processor 118 to adjust any feature(s) of imagery 110 as directed by the viewer. Display processor 118 therefore directs the presentation of imagery no by providing suitable output signals that are ultimately rendered on display 102. Display processor 118 also adjusts the imagery 110 in response to inputs received from the viewer, as appropriate.

In many embodiments, display processor 118 produces an output signal that is encoded in any standard format (e.g., ITU656 format for standard definition television signals or any format for high definition television signals) and that that can be readily converted to standard and/or high definition television signals at interface 122. In other embodiments, the functionality of display processor 118 and interface 122 may be combined in any manner.

In operation, then, receiver 108 suitably receives broadcast programming signals 105 from a content aggregator 134 or other source at program interface 128. Receiver 108 also receives and stores EPG data 140 about the various programs contained in the broadcast programming. Rather than simply providing a single static screen of information about each program, various embodiments of receiver 108 are able to dynamically provide multiple serial or parallel windows, screens or other forms of information that dynamically change over time to provide current information, to provide additional information about the program, and/or for any other purpose.

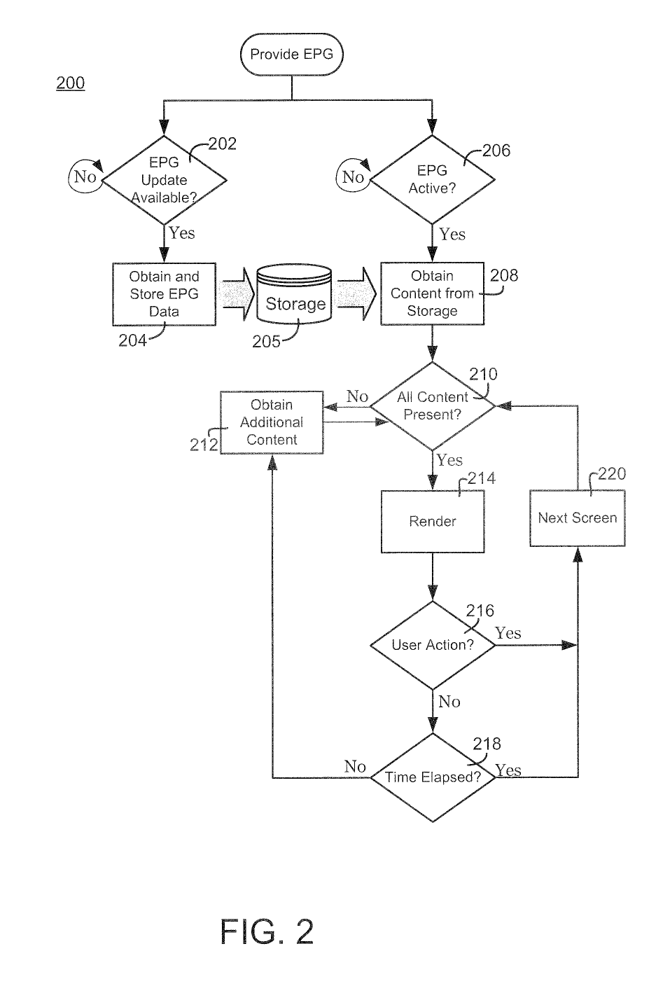

With reference now to FIG. 2, an exemplary process 200 executable within a receiver 108 to provide dynamic EPG information suitably includes the broad functions of obtaining and storing EPG data 140 from any source (functions 204, 205), and then subsequently obtaining EPG data 140 from storage 125 for subsequent processing. As noted above, the EPG data 140 for any particular program may include multiple presentation screens 142-144 that can be sequenced and rendered for presentation in any manner (function 214). In various embodiments, user actions (function 216) and/or elapsed time (function 218) can dictate a switch to a new programming screen (function 220) to thereby expand the amount and type of information that is available to the viewer. The various steps and functions shown in FIG. 2 may be various executed by the display processor 118 acting alone, or in conjunction with control logic 120 and/or any other components or logic as desired.

EPG data 140 may become available on any appropriate temporal basis (function 202). Updated data 140 may be provided on a regular basis (e.g., hourly, daily, weekly, etc.) or irregular basis (e.g., as updates become available, in response to polling from receiver 108, as space becomes available on a broadcast link, and/or in any other manner) as desired.

As noted above, EPG data 140 suitably includes multiple programming screens 142-144 for one or more programs, thereby allowing information about the program to be provided dynamically in time. Various embodiments may additional or alternately provide media content, URLs/addresses, and/or other non-textual content within EPG data 140, as desired. The EPG data 140 may be formatted in any manner, and may include data of any number of different types. Each presentation screen 142-144 may be represented in EPG data 140 by textual data, graphical data, or any sort of template that may be parsed to obtain the additional data presented to the viewer (e.g., an XML file). In various embodiments, each presentation screen 142-144 is provided as a separate logical construct that represents a different screen view rendered for the viewer on display 102.

Receiver 108 obtains EPG data 140 from any appropriate source (function 204), and stores the EPG data 140 for subsequent retrieval (function 205). In various embodiments, EPG data 140 is provided with broadcast content signals 105 received from a DBS, cable, terrestrial broadcast or other content aggregator 138. In other embodiments, EPG data 140 may be received separately from the broadcast content. Network-enabled receivers 108, for example, may receive EPG data 140 from a service 136 via network 109, or the like. EPG data 140 is appropriately stored for subsequent retrieval in storage 125, or in any other memory, disk, or other storage features available to receiver 108.

When the viewer activates the EPG feature of the receiver 108 and selects a particular program (function 206), the stored EPG content is appropriately retrieved from storage 125 (function 208) and rendered for display (function 214). The particular program may be selected in any manner; in various embodiments, the viewer simply indicates the program of interest using a remote control or other input device that is responsive to user interface features provided by the receiver 108. The viewer may select the program from grid 141, for example, to obtain additional information.

If the EPG data 140 is complete (function 210), then the information is simply rendered for output to display 102 as appropriate (function 214). Rendering function 214 may involve generating text, graphics, audio and/or video outputs to be presented to the viewer using the display, as described more fully below If the EPG data is lacking current information, however, then the additional content is obtained as needed (function 212). Additional content may be obtained, for example, by following a URL or other address embedded within EPG data 140 to obtain the requisite information from a service 136 on network 109.

To that end, various embodiments format some or all of each presentation screen 142-144 from a template or other structure in EPG data 140 that allows for the insertion of up-to-date information from any appropriate source. In some implementations, one or more of the screens 142-144 simply identifies the program of interest using conventional EPG information provided within the EPG data 140. One or more of the other screens 143-144 may then provide additional information based upon EPG data 140, or upon information received via references to a website or other service 136 that provides updated information. In the latter case, the current information may be obtained (e.g., from service 136) based upon a URL or other address contained in the EPG data 140. The information obtained may be inserted into a screen template (e.g., an XML or other format contained within the EGP data 140) for ultimate rendering and presentation to the viewer on display 102. Other embodiments may not need to obtain additional data if the information provided in each screen 142-144 is self-contained and available within EPG data 140. This may depend upon the frequency that EPG data 140 is downloaded, the frequency of changes in the relevant information, and any other factors.

Presentation screens 142-144 may be advanced in any manner (function 220). In various embodiments, the different screens 142-144 providing dynamic information can be changed in response to a user input (function 216) received via a remote control or other interface feature of receiver 108. A user may activate a button or other interface feature, for example, that leads to the presentation of a new screen on display 102. In other embodiments, the screens 142-144 are automatically advanced from one to another after an appropriate time has elapsed (function 218). Generally speaking, the appropriate time to advance would allow plenty of time for the viewer to read any content provided in the prior screen 142 without delaying for too much time so that the user becomes disinterested. The appropriate time may be predetermined to be of any appropriate length, such as on the order of a few seconds or so in some implementations, although other implementations may use other values as desired.

To present dynamic EPG content, then, the receiver 108 suitably provides a series or other sequence of presentation screens 142-144 that each convey different information about a common program. The particular information that is presented will vary widely from network to network and program to program, and could include any sort of real-time or other information obtained from a network service 136, from the content aggregator 134, or from any other source.

To provide just one example, a program guide entry relating to a future sporting event could have a combination of static and dynamic content that is presented to the viewer. Static information provided in a first screen 142 may include conventional EPG information such as the program start time, name of the program, short summary, network/channel and/or the like. Other screens 143-144 may provide additional content related to the program in any manner. This dynamic content could provide information from any number of categories, such as information about the team (e.g., team schedule, record, roster, history or trivia, etc.), information about the game (e.g., stadium history, weather forecast for the venue, legal betting information, etc.), information about the league (standings, schedules, trivia, etc.), information about the players (history, statistics, etc.) or any number of other features as appropriate.

To provide another example, an upcoming television show or movie could be associated with dynamic content such as any sort of biographical information of cast or crew, information about items/people/places featured in the movie, promotional pictures or videos, songs or other audio clips, and/or any other features as appropriate. Any number of other programs, examples and illustrations could be used in any number of equivalent embodiments.

Accordingly, new systems and techniques are presented for processing dynamic information in an electronic program guide. As the viewer identifies a current or future program listing in the EPG, the viewer may initially view a first screen (e.g., screen 142) rendered on display 102 that provides conventional EPG data (channel, broadcast time, brief summary, etc.). As the viewer lingers on the first screen 142 for an appropriate time (and/or manually selects additional information), first screen 142 may be replaced and a new screen 143 may be rendered on display 102 to provide additional information to the viewer. The dynamic information may be provided in any number of additional screen views that are logically arranged, sequenced and advanced for presentation in any manner. As noted above, such information may be textual or graphical in nature, or may incorporate audio/visual elements (e.g., photos of the players or actors, promotional video clips, and/or the like) as well. Dynamic information may be provided within the EPG data 140 provided by the content aggregator 134, as desired, or it may be obtained from a service 136 on network 109 as desired.

Although the systems and features have been frequently described herein as applying to STB receivers used in DBS broadcast systems, equivalent embodiments could apply the same concepts to program guides used in conjunction with cable broadcasting, terrestrial broadcasting, streaming media, media placeshifting, and/or any other settings as appropriate.

As used herein, the word “exemplary” means “serving as an example, instance, or illustration.” Any implementation described herein as exemplary is not necessarily to be construed as preferred or advantageous over other implementations.

While the foregoing detailed description will provide those skilled in the art with a convenient road map for implementing various embodiments of the invention, it should be appreciated that the particular embodiments described above are only examples, and are not intended to limit the scope, applicability, or configuration of the invention in any way. To the contrary, various changes may be made in the function and arrangement of elements described without departing from the scope of the invention.

What is claimed is:

1. A method executable by a receiver to provide an electronic program guide on a display, the method comprising:
receiving the electronic program guide data for a plurality of programs at the receiver, wherein the electronic program guide data for at least one program comprises a first presentation screen that describes first information related to the at least one program and a second presentation screen that describes second information different from the first information that is related to the same at least one program;
storing the electronic program guide data for the plurality of programs;
in response to a user input that selects one of the plurality of programs, retrieving the electronic program guide data for the selected program and rendering the first presentation screen to thereby output the first information about the selected program to the display; and
after the first presentation screen has been rendered, subsequently rendering the second presentation screen to thereby output the second information about the selected program to the display.

2. The method of claim 1 wherein the subsequent rendering of the second presentation screen is performed in response to a second user input.

3. The method of claim 1 wherein the subsequent rendering of the second presentation screen is performed in after the first information has been rendered for a predetermined period of time.

4. The method of claim 1 wherein the second presentation screen comprises a network address identifying a service on a network.

5. The method of claim 4 further comprising contacting the service available at the network address to thereby obtain current second information.

6. The method of claim 4 wherein the network address is a uniform resource locator.

7. The method of claim 1 wherein the electronic program guide data is received from a broadcast source.

8. The method of claim 7 wherein the electronic program guide data is received from one of a direct broadcast satellite system, a cable system, and a terrestrial television broadcast.

9. The method of claim 1 wherein the rendering comprises rendering a media clip contained within at least one of the first and second presentation screens.

10. A method executable by a television receiver to provide a dynamic electronic program guide data on a display, the method comprising:
receiving electronic program guide data for a plurality of programs at the television receiver, wherein the electronic program guide data for at least one program comprises a first presentation screen that describes first information related to the at least one program and a second presentation screen that describes second information related to the same at least one program that is different from the first information;
storing the electronic program guide data for the plurality of programs at the television receiver;
in response to a user input that selects one of the plurality of programs, retrieving the electronic program guide data for the selected program and rendering the first presentation screen to thereby output the first information about the selected program to the display; and
after rendering the first presentation screen, subsequently rendering the second presentation screen to thereby dynamically change the output to the display from the first information to the second information about the selected program.

11. The method of claim 10 wherein the subsequent rendering of the second presentation screen occurs automatically after the first presentation screen has been rendered for a predetermined period of time.

12. The method of claim 10 wherein the electronic program the subsequent rendering of the second presentation screen comprises obtaining at least some of the second information from a network service in response to an address that is received in the electronic program guide data.

13. A receiver to provide television programs for presentation on a display, the receiver comprising:
a program interface configured to receive broadcast signals from a content aggregator, wherein the broadcast signals comprise signals representing television programs and electronic program guide data, and wherein the electronic program guide data comprises, for each of at least some of the programs, a first presentation screen providing first information about the program and a second presentation screen providing second information about the program that is different from the first program;
a storage device;
a decoder configured to receive and decode the signals representing one of the television programs;
a display interface configured to provide a display output to the display; and
control logic configured to direct the storage of the electronic program guide data in the storage device and, in response to a user input, to retrieve the electronic program guide data corresponding to one of the programs, to render the first information for presentation on the display via the display interface, and to subsequently render the second information for presentation on the display via the display interface.

14. The receiver of claim 13 further comprising a network interface to a network, and wherein the control logic is configured to obtain at least some of the second information from a network service via the network interface.

15. The receiver of claim 14 wherein the second presentation screen comprises an address of the network service, wherein the control logic is further configured to obtain the at least some of the second information from the network service using the address

16. The receiver of claim 15 wherein the second presentation screen comprises a display template, and wherein the control logic is configured to render the second information in accordance with the template.

17. The receiver of claim 14 wherein the broadcast signals are received via a broadcast link that is separate from the network.

18. The receiver of claim 17 wherein the broadcast link is one of a direct broadcast satellite link, a cable broadcast link, and a terrestrial television broadcast link.

19. The receiver of claim 17 wherein the control logic is configured to automatically render the second information for presentation on the display after the first information has been displayed for a predetermined period of time.

20. The receiver of claim 17 wherein the control logic is configured to render the second information for presentation on the display in response to a user input received from the viewer.
